(19) United States
(12) Patent Application Publication
(10) Pub. No.: US 2024/0396788 A1
(43) Pub. Date: Nov. 28, 2024

(54) SYSTEM AND METHOD FOR IDENTIFYING A ROOT CAUSE OF AN ALARM IN A DATA CENTER

(71) Applicant: Honeywell International Inc., Charlotte, NC (US)

(72) Inventors: Jayaprakash Meruva, Bangalore (IN); Devanshu Dugar, Kolkata (IN); Alpesh Saraiya, Santa Clara, CA (US); Blake Clark, Oakwood, GA (US); Juvin Anthraper, Kerala (IN); Anwesh Nayak, Bangalore (IN)

(21) Appl. No.: 18/322,341

(22) Filed: May 23, 2023

(51) Int. Cl. H04L 41/0631; H04L 41/22

(52) U.S. Cl. CPC H04L 41/0631; H04L 41/22

(57) ABSTRACT

A data center has an Informational Technology (IT) system that is supported by an Operational Technology (OT) system. A correlation between one or more performance parameters of the IT system on one or more alarms of the OT system and/or one or more performance parameters of the OT system on one or more alarms of the IT system is used to ascertain possible OT system causes of an IT alarm as well as to ascertain possible IT system causes of an OT alarm. A dashboard is displayed that includes one or more alarm details of the alarm issued by an alarm source system and a listing of one or more possible root causes of the alarm that correlate to a non-alarm source system.

### TECHNICAL FIELD

The present disclosure pertains generally to a data center and more particularly to identifying root causes of an alarm in a data center.

### BACKGROUND

A data center typically includes a number of computer servers in close proximity to each other arranged in server racks. Because of the heat generated by having a number of computer servers in close proximity to each other, a data center includes numerous cooling equipment such as CRAC (computer room air conditioners) units and/or CRAH (computer room air handlers) units in order to control environmental conditions such as temperature within and around each of the server racks. It will be appreciated that a data center includes both IT (Informational Technology) system equipment and OT (Operational Technology) system equipment. In some instances, an alarm in an IT system may ultimately be at least partially caused by a problem in an associated OT system, or an alarm in an OT system may ultimately be at least partially caused by a problem in an associated IT system. A need remains for improved methods and systems of identifying root causes of alarms within data centers.

### SUMMARY

This disclosure pertains generally to a data center and more particularly to identifying root causes of an alarm in a data center. An example may be found in a method for identifying a root cause of an alarm in a data center, wherein the data center has an Informational Technology (IT) system that is supported by an Operational Technology (OT) system. The method includes storing a correlation between one or more performance parameters of the IT system on one or more alarms of the OT system and/or one or more performance parameters of the OT system on one or more alarms of the IT system. One or more current performance parameters of the OT system and/or one or more current performance parameters of the IT system are received. An alarm is received. A source of the alarm is identified as the IT system or the OT system, wherein the IT system or the OT system that is identified as the source of the alarm is the source system, and the IT system or the OT system that is not identified as the source of the alarm is the non-source system. One or more current performance parameters of the OT system and/or one or more current performance parameters of the IT system are utilized, in conjunction with the stored correlation, to determine whether one or more of the current performance parameters of the non-source system correlate to a possible root cause of the alarm of the source system. A dashboard is displayed on a display that includes one or more alarm details of the alarm issued by the source system and a listing of one or more possible root causes of the alarm that correlate to the non-source system.

Another example may be found in a method for displaying possible causes for an alarm in either an Informational Technology (IT) system or an Operational Technology (OT) system, the alarm occurring in one of the IT system and the OT system, the possible causes including possible causes from the other of the IT system and the OT system. The method includes a machine learning training stage and an operational stage. The machine learning training stage includes modulating the load on OT and/or IT system, observing and recording responses and ascertaining a correlation between one or more performance parameters of the OT system on one or more performance parameters of the IT system and/or between one or more performance parameters of the IT system on one or more performance parameters of the OT system. The operational stage includes receiving an indication of an alarm in one of the IT system and the OT system and utilizing the ascertained correlations between the one or more performance parameters of the OT system on the one or more performance parameters of the IT system and/or between the one or more performance parameters of the IT system on the one or more performance parameters of the OT system to ascertain possible root causes in the other of the IT system and the OT system. The method includes displaying on a display a dashboard that includes one or more alarm details for the alarm in one of the IT system and the OT system and a listing of one or more possible root causes within the other of the IT system and the OT system. A user is able to drill down on each of the one or more possible causes within the other of the IT system and the OT system by clicking on a possible cause.

Another example may be found in a data center monitoring system for a data center, the data center including Informational Technology (IT) equipment and Operational Technology (OT) equipment. The data center monitoring system includes an input for receiving signals from the IT equipment and signals from the OT equipment and a controller that is operably coupled to the input. The controller is configured to receive an indication of an alarm in one of the IT equipment and the OT equipment and to utilize a correlation between IT equipment and OT equipment to ascertain possible root causes of the alarm in the other of the IT system and the OT system. The controller is configured to display on a display a dashboard that includes one or more alarm details for the alarm in one of the IT equipment and the OT equipment and a listing of one or more possible root causes of the alarm within the other of the IT equipment and the OT equipment.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram showing an illustrative data center monitoring station and data center;

FIG. 2 is a flow diagram showing an illustrative method for identifying a root cause of an alarm in a data center;

FIGS. 3A and 3B are flow diagrams that together show an illustrative method for displaying possible causes for an alarm in either an Informational Technology (IT) system or an Operational Technology (OT) system of a data center;

FIG. 4 is a schematic block diagram showing features of an illustrative data center;

FIG. 5 is a schematic block diagram showing IT and OT connectivity in an illustrative data center;

FIG. 6 is a schematic block diagram showing an illustrative data center manager; and

FIGS. 7 through 10 are screen shots showing illustrative dashboards.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

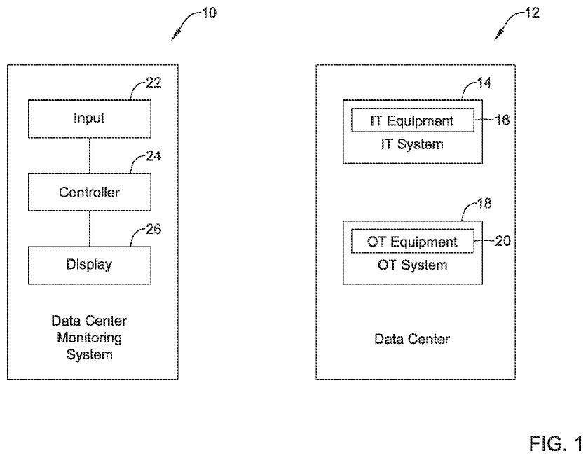

FIG. 1 is a schematic block diagram showing an illustrative data center monitoring system 10 for monitoring a data center 12. In some instances, the data center monitoring system 10 may be disposed within the data center 12. In some instances, the data center monitoring system 10 may be remote from the data center 12, and may receive relevant information from the data center 12 over one or more networks, including the Internet. In some instances, the data center 12 may be considered as including an Informational Technology (IT) system 14 that includes IT equipment 16 and an Operational Technology (OT) system 18 that includes OT equipment 20.

Information Technology (IT) refers to the use of computers to create, process, store, retrieve and exchange all kinds of data and information. Information technology systems (IT systems) are generally information systems, communications systems and/or more generally computer systems, including all hardware, software, and peripheral equipment used by IT users. In the data center context, examples of IT equipment 16 may include but are not limited to computer servers, computer networking equipment such as network switches, modems and firewalls.

Operational Technology (OT) refers to the use of hardware and software to control industrial equipment (e.g. data center equipment), and it primarily interacts with the physical world by, for example, detecting or causing a change through the direct monitoring and/or control of industrial equipment, assets, processes and/or events. The phrase Operational Technology (OT) was established to demonstrate the technological and functional differences between traditional Information Technology (IT) systems and industrial control system environments. OT technology may include, for example, industrial control equipment like programmable logic controllers (PLCs), distributed control systems (DCSs), and supervisory control and data acquisition (SCADA) systems. In the context of data centers, examples of OT equipment 20 include but are not limited to equipment that supports the operation of the IT equipment including server racks, rack sensors, rack fans, rack power generation and distribution equipment including power backup (UPS) and/or power monitoring at the rack level, cooling equipment such as CRAC (Computer Room Air Conditioning) equipment, CRAH (Computer Room Air Handling) equipment, chillers and the like.

The data center monitoring system 10 includes an input 22 for receiving signals from the IT equipment 16 and from the OT equipment 20. Example signals that may be received from the IT equipment 16 include server temperature signals, server power value signals, server fan speed signals, server CPU (Central Processing Unit) utilization value signals, network status signals, server power status signals and server communication status signals. Example signals that may be received from the OT equipment 20 include rack temperature signals, rack humidity signals, air pressure signals, air flow signals, and energy consumption signals. A controller 24 is operatively coupled to the input 22 to receive signals from the IT equipment 16 and the OT equipment 20.

The controller 24 is configured to receive an indication of an alarm in one of the IT equipment 16 and the OT equipment 20. Examples of IT alarms include one or more of a server temperature alarm, a server power alarm, a server fan speed alarm, a server CPU utilization alarm, a network error alarm, a server power alarm, and a server communication alarm. Examples of OT alarms include one or more of a rack temperature alarm, a rack humidity alarm, a rack pressure alarm, a rack air flow alarm, and a rack energy consumption alarm.

The controller 24 is configured to utilize a correlation between the IT equipment 16 and the OT equipment 20 to ascertain possible root causes of the alarm in the other of the IT system and the OT system. For example, an IT alarm may actually be at least partially caused by a problem with the OT equipment 20. In some instances, an OT alarm may actually be caused at least in part by a problem with the IT equipment 16. In some instances, the correlation between the IT equipment 16 and the OT equipment 20 may be provided in a look-up table, and the controller 24 may be configured to look up a particular piece of IT equipment 16 currently in alarm and determine which particular pieces of OT equipment 20 may be affecting that particular piece of IT equipment 16 and/or that particular alarm of that particular piece of IT equipment 16. Similarly, the controller 24 may be configured to look up a particular piece of OT equipment 20 currently in alarm and determine which particular pieces of IT equipment 16 may be affecting that particular piece of OT equipment 20 and/or that particular alarm of that particular piece of OT equipment 20.

In some instances, the correlation between the IT equipment 16 and the OT equipment 20 may include use of a machine learning model that may be implemented by the controller 24. Teaching the machine learning model may include monitoring one or more performance parameters of the IT system 14 and identifying resulting impacts on one or more performance parameters of the OT system 18. Teaching the machine learning model may include monitoring one or more performance parameters of the OT system 18 and identifying resulting impacts on one or more performance parameters of the IT system 14. Performance parameters of the IT system 14 may include one or more of a server temperature, a server power, a server fan speed, a server CPU utilization, a network error, a server power, and a server communication parameter. Performance parameters of the OT system 18 may include one or more of a temperature, a humidity, a pressure, an air flow, and an energy consumption. In some instances, teaching the machine learning model includes modulating the load on various OT equipment 20 of the OT system 18 and identifying resulting impacts on one or more performance parameters of the IT system 14. In some instances, teaching the machine learning model includes modulating the load on various IT equipment 16 of the IT system 14 and identifying resulting impacts on one or more performance parameters of the OT equipment 20. Over time, the correlation between the IT equipment 16 and the OT equipment 20 may be realized.

The data center monitoring system 10 includes a display 26 that is operatively coupled with the controller 24 so that the controller 24 may utilize the display 26 in displaying a dashboard. In some instances, the dashboard may include one or more alarm details for the alarm in one of the IT equipment 16 and the OT equipment 20. In some instances, the dashboard may include a listing of one or more possible root causes of the alarm within the other of the IT equipment 16 and the OT equipment 20. In some instances, the controller 24 may be configured to allow a user to drill down on each of the one or more possible root causes within the other of the IT equipment 16 and the OT equipment 20 by clicking on a respective possible root cause.

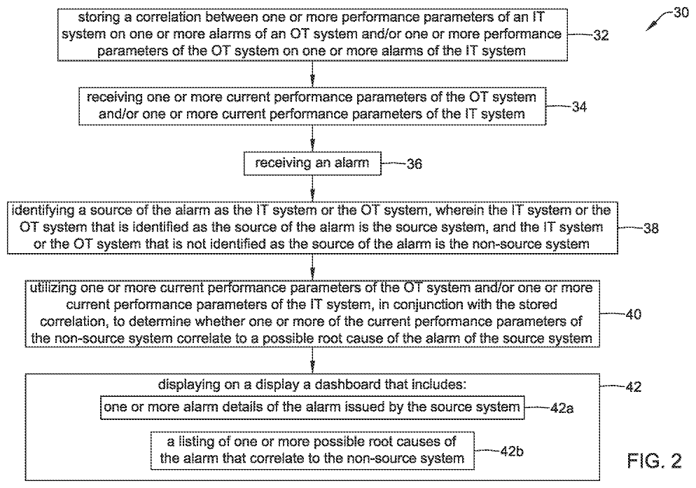

FIG. 2 is a flow diagram showing an illustrative method 30 for identifying a root cause of an alarm in a data center (such as the data center 12), wherein the data center has an Informational Technology (IT) system (such as the IT system 14) that is supported by an Operational Technology (OT) system (such as the OT system 18). The root cause of the alarm may simply be a contributor to the cause of the alarm. In some cases, the root cause of the alarm may be the primary or sole cause of the alarm. The method 30 includes storing a correlation between one or more performance parameters of the IT system on one or more alarms of the OT system and/or one or more performance parameters of the OT system on one or more alarms of the IT system, as indicated at block 32.

In some instances, the correlation includes a look-up table that provides the correlation between one or more performance parameters of the IT system on one or more alarms of the OT system and/or one or more performance parameters of the OT system on one or more alarms of the IT system. In some instances, the correlation is represented at least in part in a machine learning model, wherein teaching the machine learning model includes monitoring one or more performance parameters of the IT system and identifying resulting impacts on one or more performance parameters of the OT system. Teaching the machine learning model may include monitoring one or more performance parameters of the OT system and identifying resulting impacts on one or more performance parameters of the IT system. In some instances, teaching the machine learning model includes modulating various OT equipment of the OT system and identifying resulting impacts on one or more performance parameters of the IT system. In some instances, teaching the machine learning model includes modulating various IT equipment of the IT system and identifying resulting impacts on one or more performance parameters of the OT system.

In some instances, the one or more performance parameters of the OT system may include one or more of a temperature, a humidity, a pressure, an air flow, and an energy consumption. In some instances, the one or more performance parameters of the IT system may include one or more of a server temperature, a server power, a server fan speed, a server CPU utilization, a network error, a server power, and a server communication parameter. One or more current performance parameters of the OT system and/or one or more current performance parameters of the IT system are received, as indicated at block 34.

An alarm is received, as indicated at block 36. A source of the alarm is identified as the IT system or the OT system, wherein the IT system or the OT system that is identified as the source of the alarm is the source system, and the IT system or the OT system that is not identified as the source of the alarm is the non-source system. In some instances, the alarm includes an IT alarm, where the source system is the IT system, and the listing of one or more possible root causes of the alarm includes suspected problems with one or more pieces of OT equipment of the OT system. Examples of IT alarms include one or more of a server temperature alarm, a server power alarm, a server fan speed alarm, a server CPU utilization alarm, a network error alarm, a server power alarm, and a server communication alarm. In some instances, the alarm includes an OT alarm, where the source system is the OT system, and the listing of one or more possible root causes of the alarm includes suspected problems with one or more pieces of IT equipment of the IT system. Examples of OT alarms include one or more of a temperature alarm, a humidity alarm, a pressure alarm, an air flow alarm, and an energy consumption alarm.

One or more current performance parameters of the OT system and/or one or more current performance parameters of the IT system are utilized, in conjunction with the stored correlation, to determine whether one or more of the current performance parameters of the non-source system correlate to a possible root cause of the alarm of the source system, as indicated at block 40. A dashboard is displayed on a display (such as the display 26), as indicated at block 42. The dashboard may include one or more alarm details of the alarm issued by the source system, as indicated at block 42a. The dashboard may include a listing of one or more possible root causes of the alarm that correlate to the non-source system, as indicated at block 42b. In some instances, a user is able to obtain additional information on each of the one or more possible root causes correlated to the non-source system by clicking on a respective root cause.

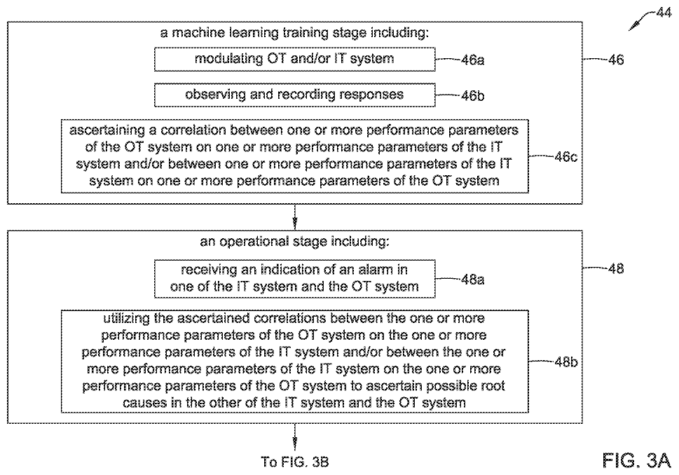

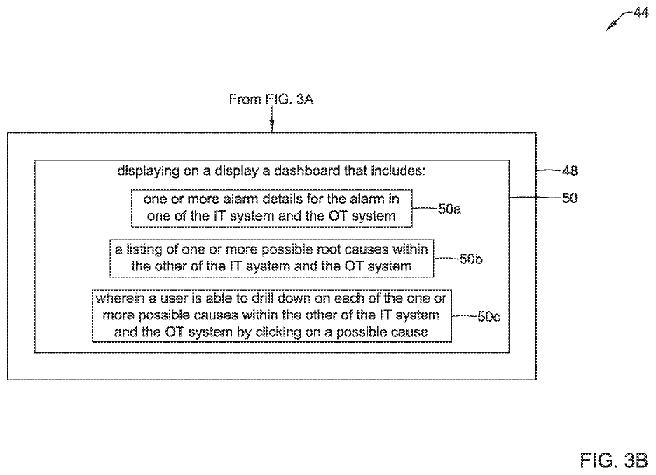

FIGS. 3A and 3B are flow diagrams that together show an illustrative method 44 for displaying possible causes for an alarm in either an Informational Technology (IT) system (such as the IT system 14) or an Operational Technology (OT) system (such as the OT system 18), the alarm occurring in one of the IT system and the OT system, the possible causes including possible causes from the other of the IT system and the OT system. The method 44 includes a machine learning training stage, as indicated at block 46. The machine learning training stage includes modulating the load of at least part of the OT system and/or the IT system, as indicated at block 46a. The machine learning training stage includes observing and recording responses, as indicated at block 46b. The machine learning training stage includes ascertaining a correlation between one or more performance parameters of the OT system on one or more performance parameters of the IT system and/or between one or more performance parameters of the IT system on one or more performance parameters of the OT system.

The method 44 includes an operational stage, as indicated at block 48. The operational stage includes receiving an indication of an alarm in one of the IT system and the OT system, as indicated at block 48a. The operational stage includes utilizing the ascertained correlations between the one or more performance parameters of the OT system on the one or more performance parameters of the IT system and/or between the one or more performance parameters of the IT system on the one or more performance parameters of the OT system to ascertain one or more possible root causes in the other of the IT system and the OT system, as indicated at block 48b.

Continuing on FIG. 3B, the operational stage includes displaying a dashboard on a display, as indicated at block 50. The dashboard includes one or more alarm details for the alarm in one of the IT system and the OT system, as indicated at block 50a. The dashboard includes a listing of one or more possible root causes within the other of the IT system and the OT system, as indicated at block 50b. A user is able to drill down on each of the one or more possible causes within the other of the IT system and the OT system by clicking on a possible cause, as indicated at block 50c.

In some instances, the alarm includes an IT alarm, and the possible root causes include suspected problems with one or more pieces of OT equipment. In some instances, the possible causes may further include suspected problems with one or more pieces of IT equipment. In some instances, the alarm includes an OT alarm, and the possible causes include suspected problems with one or more pieces of IT equipment. In some instances, the possible causes further include suspected problems with one or more pieces of OT equipment. As an example, an IT alarm may include one or more of a server temperature alarm, a server power alarm, a server fan speed alarm, a server CPU utilization alarm, a network error alarm, a server power alarm, and a server communication alarm. As another example, an OT alarm may include one or more of a temperature alarm, a humidity alarm, a pressure alarm, an air flow alarm, and an energy consumption alarm.

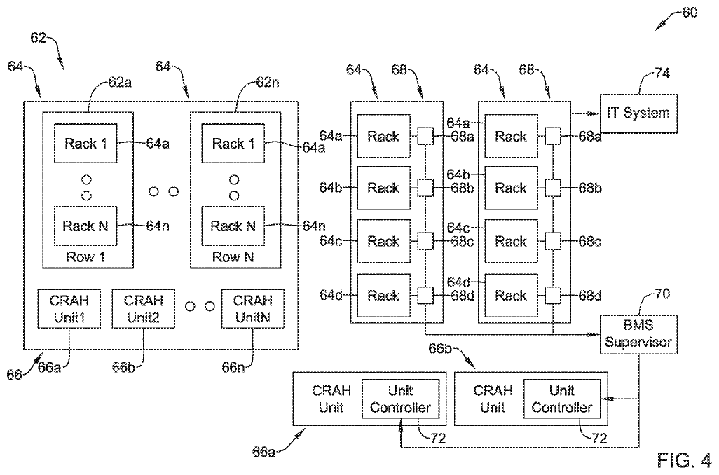

FIG. 4 is a schematic block diagram showing features of a data center 60 that may be considered as being an example of the data center 12 shown in FIG. 1. The data center 60 includes a number of rows 62 of server racks, individually labeled as 62a through 62n. Each of the rows 62 includes a number of server racks 64, individually labeled as 64a through 64n. It will be appreciated that the data center 60 may include any number of rows 62 of server racks, and that each row 62 may include any number of server racks 64. While not shown, each server rack will include a number of individual servers. The data center 60 includes a number of CRAH (Computer Room Air Handler) units 66, individually labeled as 66a, 66b through 66n. Each of the CRAH units 66 may receive chilled water from a chilled water source (chiller not shown), and may blow air over a heat exchanger through which the chilled water is circulating in order to chill the air, which is subsequently used for removing heat from around the server racks 64.

Each server rack 64, individually labeled as 64a, 64b, 64c and 64d along the right side of FIG. 4, includes in-rack cooling and also includes external rack sensors 68, individually labeled as 68a. 68b, 68c and 68d. The external rack sensors 68 may include temperature sensors and humidity sensors, for example. The external rack sensors 68 are operably coupled with a BMS Supervisor 70, which may be considered as being part of the OT system. The BMS Supervisor 70 oversees operation of the CRAH units 66. Each of the CRAH units 66 may include a unit controller 72 that receives commands from the BMS Supervisor 70. In the example shown, the server racks 64 communicate with an IT system 74.

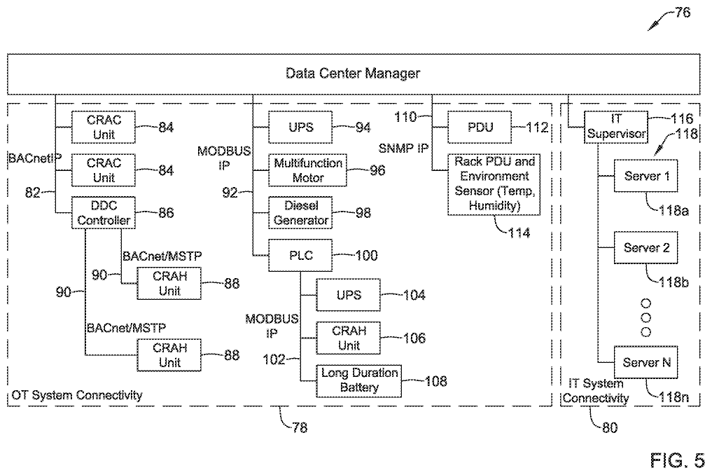

FIG. 5 is a schematic block diagram showing IT and OT connectivity in an illustrative data center manager 76. As can be seen, the data center manager 76 includes equipment and devices within an OT system connectivity section 78 and an IT system connectivity section 80. The OT system connectivity section 78 includes a number of OT devices that are operably coupled with a BACnet IP network 82, including several CRAH units 84. A DDC (Direct Digital Control) controller 86 is operably coupled with the BACnet IP network 82. The DDC controller 86 is operably coupled with several CRAC units 88 via a BACnet/MSTP network 90. The OT system connectivity section 78 includes a number of OT devices that are operably coupled with a MODBUS IP network 92, including a UPS (Uninterruptable Power Supply) 94, a multifunction meter 96, a diesel generator 98 and a PLC (Programmable Logic Controller) 100. The PLC 100 is operably coupled to a MODBUS (IP or RTU) network 102 to a UPS 104, a CRAC unit 106 and a long duration battery 108. The OT system connectivity section 78 includes several OT devices that are operably coupled with an SNMP IP network 110, including a PDU 112 and sensors 114 (including a Rack PDU sensor and environmental sensors such as temperature and humidity sensors). The IT connectivity section 80 includes an IT Supervisor 116 that is operably coupled with a number of servers 118, individually labeled as 118a, 118b through 118h. Each of the servers 118 is hosted by a rack in the data center.

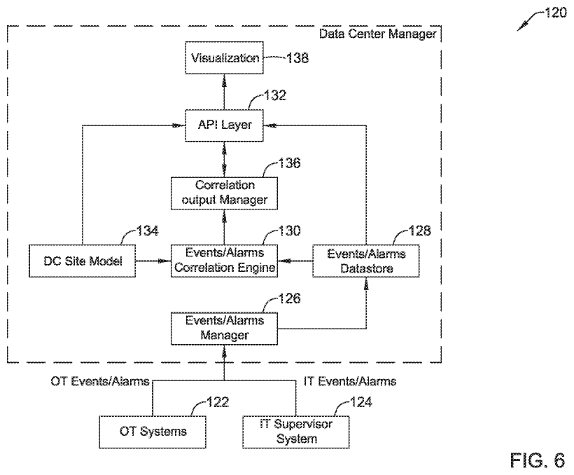

FIG. 6 is a schematic block diagram showing an illustrative data center manager 120. The data center manager 120 may be considered as an example of the data center manager 76, and may share features and elements with the data center manager 76. In some instances, the data center manager 120 may communicate with OT systems 122 and with an IT Supervisor System 124. The OT systems 122 may generate OT events and alarms while the IT Supervisor System 124 may generate IT events and alarms. The OT events and alarms, as well as the IT events and alarms, pass to an Alarm/Event Manager 126 within the data center manager 120. The Alarm/Event Manager 126 communicates with an Event/Alarm Database 128. The Event/Alarm Database 128 communicates with an Events/Alarms Correlation Engine 130 as well as an API (Application Programming Interface) Layer block 132. A DC Site Model block 134 also communicates with both the Events/Alarms Correlation Engine 130 and the API Layer block 132. The Events/Alarms Correlation Engine 130 communicates with a Correlation Output Manager block 136, which has two-way communication with the API Layer block 132. The API Layer block 132 communicates with a Visualization block 138, which in some instances generates dashboards for display.

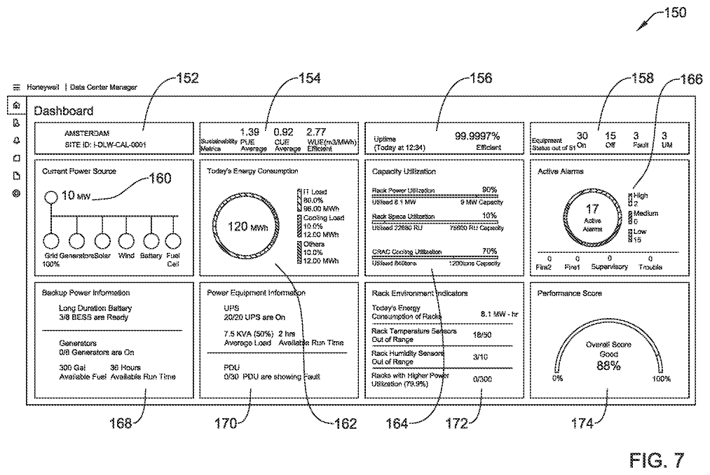

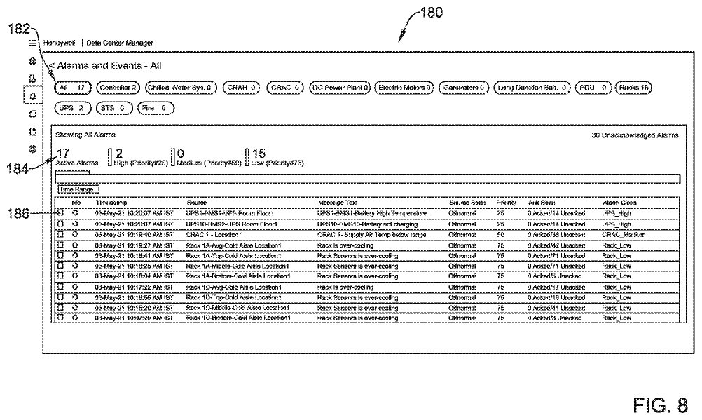

FIGS. 7 through 10 are screen shots showing illustrative dashboards. FIG. 7 is a screen shot of an illustrative dashboard 150 that may be displayed. The illustrative dashboard 150 includes a number of widgets, including in a first row a Site Info widget 152, a Sustainability Metrics widget 154, an Uptime widget 156 and an Equipment Status widget 158. A second row includes a Current Power Source widget 160, a Today's Energy Consumption widget 162, a Capacity Utilization widget 164 and an Alarms widget 166. A third row includes a Backup Power Information widget 168, a Power Equipment Information widget 170, a Rack Environmental Indicators widget 172 and a Performance Score 174. By clicking on the Alarms widget 166, a dashboard 180 is displayed, as shown in FIG. 8.

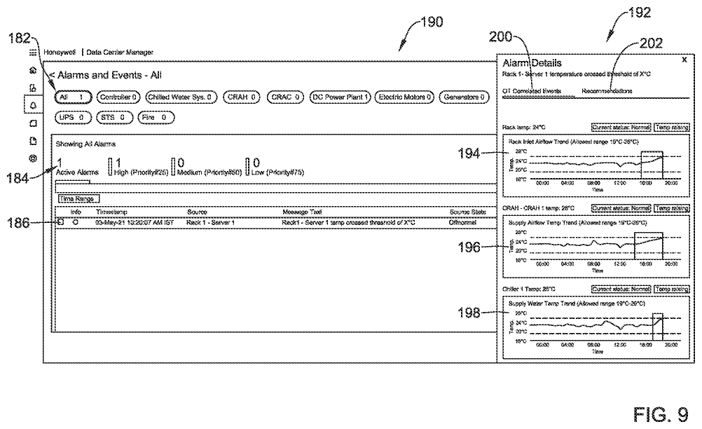

As seen in FIG. 8, the dashboard 180 includes a toolbar 182 that allows a user to select which alarms they wish to have displayed. The toolbar 182 includes options such as ALL, Controller, Chilled Water System, CRAH, CRAC, DC Power Plant, Electric Motors, Generators, Long Duration Battery, PDU, Racks, UPS, STS and Fire. As shown, ALL is highlighted, meaning that it has been selected. The dashboard 180 includes a priority section 184, indicating that there are currently 17 active alarms, 2 of which are high priority, 15 of which are low priority and none of which are medium priority. The dashboard 180 includes a listing of each of the active alarms, including an active alarm 186, which is the first alarm listed and which corresponds to a Rack 1/Server 1 alarm. Selecting this alarm, such as by clicking on the active alarm 186, will cause a dashboard 190 to be displayed, as shown in FIG. 9.

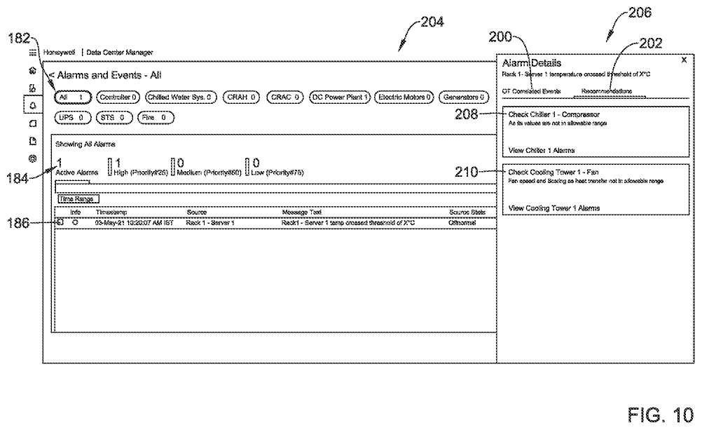

As seen in FIG. 9, the dashboard 190 is similar to the dashboard 180, but includes a popup 192 that provides alarm details for the selected alarm 186. In some instances, the dashboard 190 may continue to display all of the alarms, as shown in FIG. 8. In some instances, as shown, the dashboard 190 may only display the selected alarm 186. In some instances, the popup 192 may include correlated events from IT system and OT system. The correlation engine will identify associated OT assets, including racks, CRAH, CRC, chillers and cooling towers, etc. In some instances, trends will be displayed in order to enable faster user action in resolving the selected alarm 186. In this particular example, the IT alarm is that the Rack 1 Server 1 temperature has increased such that it has passed a temperature threshold. The popup 192 includes a section 194 showing the rack inlet airflow trend. While the airflow is currently within normal range, it is increasing. The popup 192 includes a section 196 that includes the supply airflow temperature trend. While the supply airflow temperature is currently within normal range, it is increasing. The popup 192 includes a section 198 showing the chiller 1 temperature trend. While the chiller 1 temperature is currently within normal range, it is increasing. Each of these may be possible OT causes for the IT alarm. The popup 192 includes a header button OT Correlated Events button 200 and a Recommendations button 202. In FIG. 9, the header button OT Correlated Events button 200 has been selected. Selecting the Recommendations button 202 will cause display of a dashboard 204, as shown in FIG. 10.

FIG. 10 shows a dashboard 204. The dashboard 204 is similar to the dashboard 180, but includes a popup 206. In some instances, the dashboard 204 may continue to display all of the alarms, as shown in FIG. 8. In some instances, as shown, the dashboard 204 may only display the selected alarm 186. The popup 206 now displays several recommendations. The recommendations include a recommendation 208 to check the chiller 1 compressor, as its values are not in allowable range. The recommendations include a recommendation 210 to check the fan in cooling tower 1 because fan speed and scaling as heat transfer are not in allowable range. These are just examples.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A method for identifying a root cause of an alarm in a data center, wherein the data center has an Informational Technology (IT) system that is supported by an Operational Technology (OT) system, the method comprising:
storing a correlation between one or more performance parameters of the IT system on one or more alarms of the OT system and/or one or more performance parameters of the OT system on one or more alarms of the IT system;
receiving one or more current performance parameters of the OT system and/or one or more current performance parameters of the IT system;
receiving an alarm;
identifying a source of the alarm as the IT system or the OT system, wherein the IT system or the OT system that is identified as the source of the alarm is the source system, and the IT system or the OT system that is not identified as the source of the alarm is the non-source system;
utilizing one or more current performance parameters of the OT system and/or one or more current performance parameters of the IT system, in conjunction with the stored correlation, to determine whether one or more of the current performance parameters of the non-source system correlate to a possible root cause of the alarm of the source system;
displaying on a display a dashboard that includes:
one or more alarm details of the alarm issued by the source system; and
a listing of one or more possible root causes of the alarm that correlate to the non-source system.

2. The method of claim 1, wherein a user is able to obtain additional information on each of the one or more possible root causes correlated to the non-source system by clicking on a respective root cause.

3. The method of claim 1, wherein the correlation comprises a look-up table that provides the correlation between one or more performance parameters of the IT system on one or more alarms of the OT system and/or one or more performance parameters of the OT system on one or more alarms of the IT system.

4. The method of claim 1, wherein the correlation is represented at least in part in a machine learning model, wherein teaching the machine learning model includes:
monitoring one or more performance parameters of the IT system and identifying resulting impacts on one or more performance parameters of the OT system; and/or
monitoring one or more performance parameters of the OT system and identifying resulting impacts on one or more performance parameters of the IT system.

5. The method of claim 4, wherein teaching the machine learning model includes:
modulating various OT equipment of the OT system and identifying resulting impacts on one or more performance parameters of the IT system; and/or
modulating various IT equipment of the IT system and identifying resulting impacts on one or more performance parameters of the OT system.

6. The method of claim 1, wherein:
the alarm comprises an IT alarm, where the source system is the IT system; and
the listing of one or more possible root causes of the alarm comprise suspected problems with one or more pieces of OT equipment of the OT system.

7. The method of claim 6, wherein the IT alarm includes one or more of a server temperature alarm, a server power alarm, a server fan speed alarm, a server CPU utilization alarm, a network error alarm, a server power alarm, and a server communication alarm.

8. The method of claim 7, wherein the one or more performance parameters of the OT system includes one or more of a temperature, a humidity, a pressure, an air flow, and an energy consumption.

9. The method of claim 1, wherein:
the alarm comprises an OT alarm, where the source system is the OT system; and
the listing of one or more possible root causes of the alarm comprise suspected problems with one or more pieces of IT equipment of the IT system.

10. The method of claim 9, wherein the OT alarm includes one or more of a temperature alarm, a humidity alarm, a pressure alarm, an air flow alarm, and an energy consumption alarm.

11. The method of claim 10, wherein the one or more performance parameters of the IT system includes one or more of a server temperature, a server power, a server fan speed, a server CPU utilization, a network error, a server power, and a server communication parameter.

12. A method for displaying possible causes for an alarm in either an Informational Technology (IT) system or an Operational Technology (OT) system, the alarm occurring in one of the IT system and the OT system, the possible causes including possible causes from the other of the IT system and the OT system, the method comprising:
a machine learning training stage comprising:
modulating OT and/or IT system;
observing and recording responses;
ascertaining a correlation between one or more performance parameters of the OT system on one or more performance parameters of the IT system and/or between one or more performance parameters of the IT system on one or more performance parameters of the OT system;
an operational stage comprising:
receiving an indication of an alarm in one of the IT system and the OT system;
utilizing the ascertained correlations between the one or more performance parameters of the OT system on the one or more performance parameters of the IT system and/or between the one or more performance parameters of the IT system on the one or more performance parameters of the OT system to ascertain possible root causes in the other of the IT system and the OT system;
displaying on a display a dashboard that includes:
one or more alarm details for the alarm in one of the IT system and the OT system;
a listing of one or more possible root causes within the other of the IT system and the OT system; and
wherein a user is able to drill down on each of the one or more possible causes within the other of the IT system and the OT system by clicking on a possible cause.

13. The method of claim 12, wherein:
the alarm comprises an IT alarm; and
the possible root causes comprise suspected problems with one or more pieces of OT equipment.

14. The method of claim 13, wherein the possible causes further comprise suspected problems with one or more pieces of IT equipment.

15. The method of claim 12, wherein:
the alarm comprises an OT alarm; and
the possible causes comprise suspected problems with one or more pieces of IT equipment.

16. The method of claim 15, wherein the possible causes further comprise suspected problems with one or more pieces of OT equipment.

17. The method of claim 12, wherein an IT alarm includes one or more of a server temperature alarm, a server power alarm, a server fan speed alarm, a server CPU utilization alarm, a network error alarm, a server power alarm, and a server communication alarm.

18. The method of claim 12, wherein an OT alarm includes one or more of a temperature alarm, a humidity alarm, a pressure alarm, an air flow alarm, and an energy consumption alarm.

19. A data center monitoring system for a data center, the data center including Informational Technology (IT) equipment and Operational Technology (OT) equipment, the data center monitoring system comprising:
an input for receiving signals from the IT equipment and signals from the OT equipment;
a controller operably coupled to the input, the controller configured to:
receive an indication of an alarm in one of the IT equipment and the OT equipment;
utilize a correlation between IT equipment and OT equipment to ascertain possible root causes of the alarm in the other of the IT system and the OT system;
display on a display a dashboard that includes:
one or more alarm details for the alarm in one of the IT equipment and the OT equipment; and
a listing of one or more possible root causes of the alarm within the other of the IT equipment and the OT equipment.

20. The data center monitoring system of claim 19, wherein the controller is configured to allow a user is drill down on each of the one or more possible root causes within the other of the IT equipment and the OT equipment by clicking on a respective possible root cause.
